(19) United States
(12) Patent Application Publication
(10) Pub. No.: US 2007/0160095 A1
(43) Pub. Date: Jul. 12, 2007

(54) Laser diode controller and method for controlling laser diode by automatic power control circuit

(76) Inventors: Kentaro Kitagawa, Yokohama-shi (JP); Hiroto Ishibashi, Yokohama-shi (JP)

Correspondence Address: SMITH, GAMBRELL & RUSSELL, 1850 M STREET, N.W., SUITE 800, WASHINGTON, DC, 20036, US

(21) Appl. No.: 11/439,424

(22) Filed: May 24, 2006

(30) Foreign Application Priority Data
May 26, 2005 (JP) 2005-154082

(51) Int. Cl. H01S 3/13

(52) U.S. Cl. 372/29.012

(57) ABSTRACT

This invention provides an automatic power control (APC) circuit for keeping an extinction ratio constant even when the efficiency of a laser diode (LD) deteriorates. The APC circuit according to this invention stores first control data for deciding the relationship between a bias current Ib and a modulation current Im so that the extinction ratio under a certain target power is a predetermined value. A central processing unit (CPU) decides the bias current Ib and modulation current Im on the basis of a current optical output power and the first control data and supplies them to an LD driver. The APC circuit also stores second control data for deciding the correction value for the optical output power corresponding to the temperature of the LD. The CPU acquires the current temperature before deciding the bias current Ib, decides a correction value corresponding to the current temperature according to the second control data, and corrects the target power. Thereafter, the CPU computes the bias current Ib on the basis of the corrected target power.

### BACKGROUND OF THE INVENTION

1. Field of the Invention

This invention relates to an automatic power control circuit for stabilizing an optical output power of a laser diode and a method for controlling the laser diode.

2. Description of the Related Art

A circuit for regulating the current quantity to be supplied to a laser diode (LD) to stabilize its optical output power is referred to as an automatic power control (APC) circuit. The Japanese Patent Application laid open as JP-H11-135871A discloses an example of the APC circuit. This APC circuit regulates a bias current and a modulation current to be supplied to the LD according to a change in an ambient temperature, thereby stabilizing the optical output power of the LD and its extinction ratio. In addition, the APC circuit disclosed detects secular deterioration of the LD on the basis of the output from a photodiode (PD) for detecting the optical output power of the LD to regulate the bias current.

However, it is difficult to compensate for short-period deterioration in the luminous efficiency (hereinafter simply referred to as an efficiency) of the LD at a high ambient temperature by the conventional APC circuit. Specifically, the LD has a temperature characteristic that the threshold current increases at a high temperature and so the efficiency greatly deteriorates. Where the threshold current increases, the driving current of the LD necessarily increases and the heat generation of the LD also increases. As a result, positive feedback that the efficiency further deteriorates acts so that the LD becomes gradually incapable of generating a target optical output power (hereinafter simply referred to as a target power). Where the APC circuit still functions, it further increases the driving current in order to compensate for the deterioration of the optical output power. Thus, the positive feedback further acts so that the LD will be eventually broken.

This invention intends to provide an APC circuit capable of keeping constant the extinction ratio and optical output power even when the efficiency of a laser diode (LD) deteriorates at a high ambient temperature, and a method for controlling the LD on the basis of the APC circuit.

### SUMMARY OF THE INVENTION

The first aspect of this invention relates to an automatic power control circuit for stabilizing an optical output power and an extinction ratio of a laser diode by supplying a bias current and a modulation current to the laser diode. The automatic power control circuit includes a first and a second storage, a control processing unit and a signal creating unit. The first storage stores first control data correlating the bias current and the modulation current supplied to the laser diode which simultaneously give a predetermined target power and a predetermined extinction ratio. The central processing unit measures the current optical output power, computes the bias current on the basis of a difference between the target power and the current optical output power, and decides the modulation current corresponding to the bias current obtained by computation according to the first control data. The signal creating unit creates a control signal corresponding to the bias current and modulation current thus decided and supplies it to the laser diode. The second storage stores second control data correlating a temperature of the laser diode and a correction value for the optical output power. The central processing unit, before deciding the bias current, measures the temperature of the laser diode, decides the correction value for the optical output power corresponding to the temperature measured according to the second control data, and corrects the target power on the basis of the correction value. Thereafter, the central processing unit computes the bias current using a difference between the corrected target power and the current optical output power. The bias current may be computed by multiplying the difference between the corrected target power and the current optical output power by a constant. The correction value corresponding to the temperature of the laser diode may be an attenuation of the target power necessary to stabilize the extinction ratio to the temperature of the laser diode at the predetermined value at the temperature.

The second control data may be a look-up table for storing a plurality of correction values correlated with a plurality of temperatures. The central processing unit, when the current temperature is different from the temperatures set in the look-up table, interpolates the correction values in the look-up table to compute the correction value corresponding to the current temperature.

Another aspect of this invention relates to a method for controlling a laser diode by supplying a bias current and a modulation current to the laser diode to stabilize an optical output-power and an extinction-ratio. This method includes the following steps of (a) measuring a current temperature of the laser diode; (b) deciding a correction value corresponding to the current temperature; (c) correcting a target power of the laser diode on the basis of the correction value; (d) measuring a current optical output power of the laser diode; (e) deciding the bias current on the basis of a difference between the optical target power and the current optical output power; (f) deciding the modulation current on the basis of the control data defining the relationship between the target power and the extinction ratio which simultaneously satisfies the target power and the extinction ratio; and (g) supplying the bias current and modulation current thus decided to the laser diode. The step (d) may be executed prior to the steps from (a) to (c) of deciding the target power.

### BRIEF DESCRIPTION OF THE DRAWINGS

FIG. 1 is a block diagram schematically showing an automatic power control circuit according to an embodiment of this invention.

FIG. 2 is a schematic view showing a bias current and a modulation current for stabilizing an extinction ratio.

FIG. 3 is a graph showing the current/optical output power characteristic of an LD and its dependency on a temperature.

FIG. 4 is a graph showing the relationship between a bias current and a modulation current, which gives a target extinction ratio and a modulation current.

FIG. 5 is a view showing correction of a target power.

FIG. 6A is a graph showing the relationship between the temperature of the LD and the correction value for the target power; and FIG. 6B is a table showing the data corresponding to FIG. 6A.

FIG. 7 is a control block diagram schematically showing automatic power control according to an embodiment of this invention.

FIG. 8 is a flowchart showing the procedure of automatic power control according to an embodiment of this invention.

### DESCRIPTION OF THE PREFERRED EMBODIMENTS

Now referring to the attached drawings, a detailed explanation will be given of various embodiments of this invention. In the respective drawings, like reference symbols refer to like elements in order to avoid overlaps of explanation.

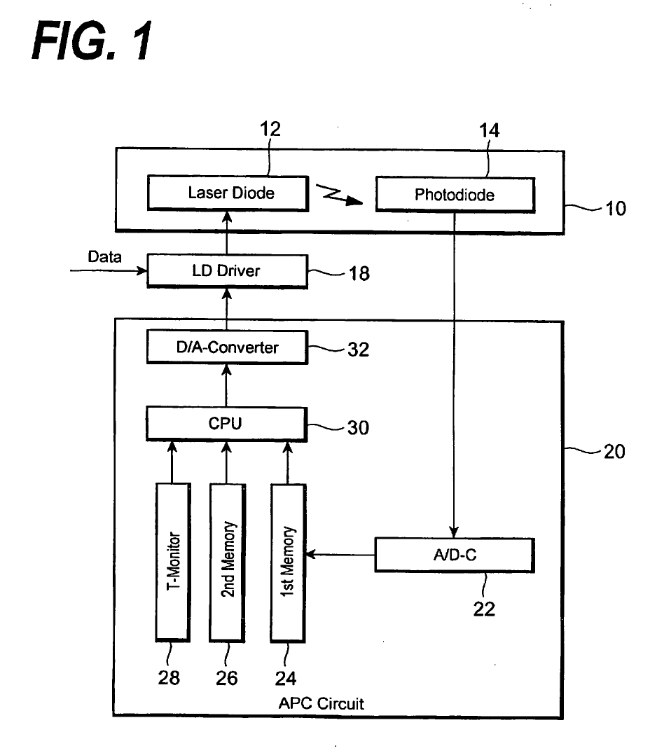

FIG. 1 is a block diagram schematically showing the configuration of an automatic power control (APC) according to this invention. An APC circuit 20 includes an A/D converter (A/D-C) 22, a first storage (memory) 24, a second storage (memory) 26, a temperature monitor 28, a central processing unit (CPU) 30 and a D/A converter (D/A-C) 32. The APC circuit 20 regulates the bias current (Ib) and modulation current (Im) to be supplied to an LD 12 loaded on a laser module 10, thereby continuing to keep constant the optical output power of the LD 12 and its extinction ratio. The laser module 10 includes a photodiode (PD) 14 for monitoring the optical output power of the LD 12 in addition to the LD 12. An LD driver 18 adds the modulation current Im to the bias current Ib and supplies their sum to the LD 12. The modulation current Im is turned On/Off according to the state “1” or “0” of an input data. The bias current Im and modulation current Im depend on the control signal output from the APC circuit 20 to the LD driver 18.

A monitor PD 14 creates an optical current I_{PD} corresponding to the average optical output power of the LD 12. The A/D converter 22 converts this optical current I_{PD} into a digital value. The optical current I_{PD} may be directly converted into the digital value, or otherwise once converted in a voltage value which will be thereafter converted into the digital value. The digital value thus obtained is temporarily stored in the first storage 24. On the other hand, the second storage 26 within the APC circuit 20 stores control data to be used by the APC circuit.

The temperature monitor 28 creates a signal corresponding to the temperature of the LD 12. The temperature monitor 28 includes a temperature sensor for measuring the temperature of the LD 12 and an A/D converter for converting the analog signal output from the temperature sensor into the digital value.

The CPU 30 decides the bias current Ib and modulation current Im to be supplied to the LD 12 using the value of the present optical output power temporarily stored in the first storage 24 and the present temperature output from the temperature monitor 28, and supplies the digital values corresponding their values to the D/A-C 32. The D/A-C 32 converts the digital values into the analog values to be supplied to the LD driver 18. In response to the analog signals, the LD driver 18 supplies the bias current Ib and modulation current Im decided by the CPU 30.

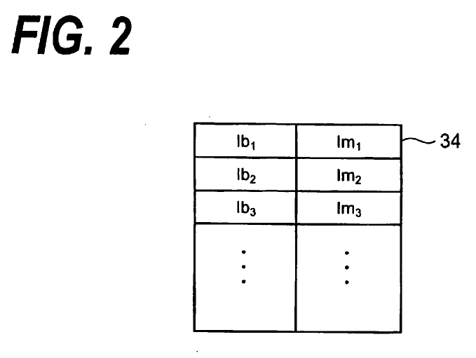

As described above, the CPU 30 decides the bias current Ib and the modulation current Im so that the optical output power of the LD 12 and its extinction ratio are predetermined target values, respectively. More specifically, a difference between the optical output power observed and the predetermined target power is multiplied by a predetermined constant to compute a single digital value corresponding to a new bias current Ib. On the other hand, a combination of the bias current Ib and the modulation current Im which gives the target extinction ratio is decided as a value intrinsic to an individual LD according to the temperature. For this reason, control data are previously acquired which represent the relationship between the bias current and the modulation current which gives the target power and the target extinction ratio. For example, the APC operation is executed to obtain the target power. In addition, Ib, Im capable of giving the target extinction ratio at a plurality of temperatures are measured, thus computing Ib, Im at a temperature other than the measured temperatures by interpolation on the basis of the measured values. The CPU 30 creates a look-up table (LUT) and an n^{th}-order homogeneous equation (n is an integer) represented by Im=aₙIbⁿ+aₙ₋₁Ibⁿ⁻¹+ . . . a₁Ib+a₀ on the basis of Ib, Im at each temperature, and the coefficients aₙ, aₙ₋₁, . . . , a₀ may be stored in the second storage 26. In this embodiment, it is assumed that an LUT 34 as shown in FIG. 2 is stored in the second storage 26. During the APC operation, the modulation currents corresponding to the bias currents are decided according to these control data.

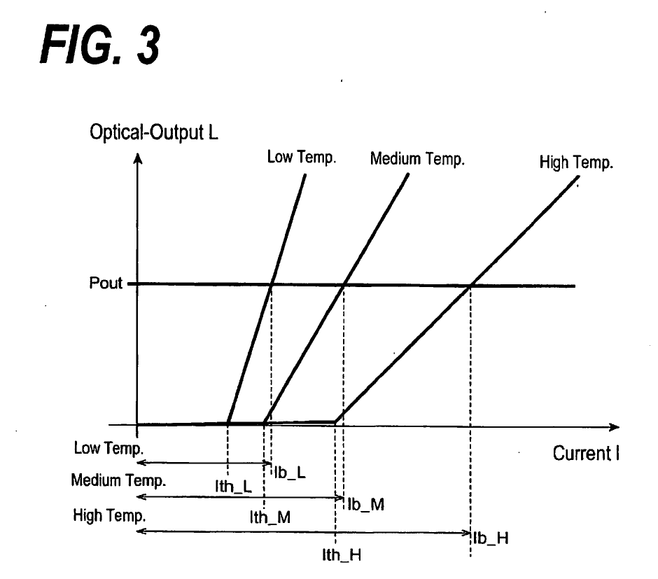

In the following, a detailed explanation will be given of the feature of the APC operation by the APC circuit 20 according to this invention. For convenience of understanding, first, the algorithm of a conventional APC will be explained. FIG. 3 is a graph showing the relationship (I-L characteristic) between the current I supplied to the LD and the optical output power L and its temperature dependency. In this graph, the threshold currents at a low temperature, medium (room) temperature and high temperature are represented as Ith_L, Ith_M and Ith_H, respectively and the currents giving the predetermined optical output power at the low temperature, medium temperature and high temperature are represented as Ib_L, Ib_M and Ib_H, respectively.

When the current I exceeds the threshold current Ith of the LD, the LD emits light. The optical output power of the LD increases with a constant slope efficiency as the current increases. As the ambient temperature rises, the threshold current increases and the slope efficiency deteriorates. Thus, the current necessary to obtain the predetermined optical output power increases as the ambient temperature rises. For this reason, in order to keep constant the optical output power and extinction ratio according to changes in the ambient temperature, the conventional APC circuit regulates the bias current Ib and the modulation current Im to be supplied to the LD according to the ambient temperature.

Generally, the modulation frequency characteristic of the LD extends to a high frequency band as the supplied current increases. Taking this characteristic into consideration, in order to obtain a preferred optical output power from the LD, it is desirable to set the target power in the APC operation at a larger value, thereby increasing the supplied current.

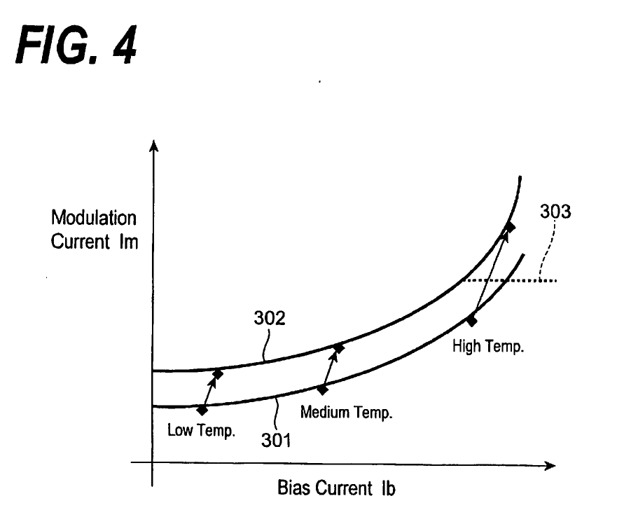

However, when the supplied current is increased, the temperature of the LD rises and its efficiency deteriorates. Therefore, it is difficult to keep constant the optical output power in a temperature range from the low temperature to the high temperature. FIG. 4 shows the relationship (Ib-Im characteristic) between a bias current Ib and a modulation current Im which realizes the predetermined target power and target extinction ratio. Graph 301 indicates the Ib-Im characteristic for a relatively small target power. As described above, in order to increase an applied current to maintain the high frequency characteristic of the LD, the target power must be set at a high value. Graph 302 indicates the relationship between the bias current Ib and modulation current Im which gives the target extinction ratio at a higher target power. These characteristics 301 and 302, as in the case of the LUT 34 shown in FIG. 2, can be acquired by measuring the bias currents Ib and modulation currents Im at a plurality of temperatures and interpolating/extrapolating the values thus measured.

When the bias current is increased under the high temperature environment, the temperature of the LD further rises and the efficiency of the LD deteriorates. The extinction ratio refers to the ratio of the optical output power (optical output corresponding to data “1”) when the modulation current fully flows to that when the optical output power (optical output corresponding to data “0”) when the modulation current is zero. Therefore, if the efficiency deteriorates, the modulation current for giving a predetermined extinction ratio increases. However, since the bias current is generally set at a maximum value, as shown in FIG. 4, under the high temperature environment, dotted line 303 deviated from the graph 302 which is an ideal Ib-Im characteristic represents an actual Ib-Im characteristic.

When the efficiency deteriorates, the APC circuit 20 detects that the optical output power has not reached the target value and automatically increases the current to be supplied to the LD. Thus, the heat generation of the LD 12 further increases and so the efficiency further deteriorates. Eventually, it becomes impossible to set the optical output power and extinction ratio at predetermined values. In order to obviate such inconvenience, the APC circuit 20 according to this embodiment corrects the target power in APC at a high temperature to restrain the bias current and modulation current, thereby stabilizing the optical output power and extinction ratio.

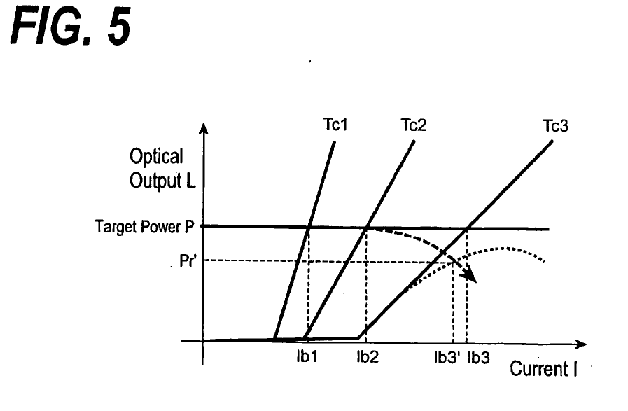

In the following, referring to FIG. 5, an explanation will be given of the theory for stabilizing the optical output power and modulation current. FIG. 5 is a view showing the manner of correcting the target optical output power. Namely, FIG. 5 shows the I-L characteristic of the LD 12 at each of a low temperature Tc1, a medium temperature Tc2 and a high temperature Tc3. As regards the high temperature Tc3, an ideal characteristic is indicated by solid line and the actual characteristic which reflects the deterioration of the efficiency is indicated by dotted line.

Assuming that the target optical output power is Pr, in an ideal case, the currents to be supplied to the LD 12 in order to acquire equal optical output powers Pr at the temperatures Tc1, Tc2 and Tc3 are Ib1, Ib2 and Ib3, respectively. On the other hand, in the actual case where the efficiency greatly deteriorates at the high temperature, as indicated in dotted line, the optical output power is saturated. Therefore, in this invention, at the high temperature Tc3, the target optical power is reduced to Pr′ so that the APC sets the applied current at Ib3′ lower than Ib3. As a result, the temperature rise in the LD 12 due to the applied current is alleviated, and so the positive feedback effect between the applied current and optical output power can be alleviated.

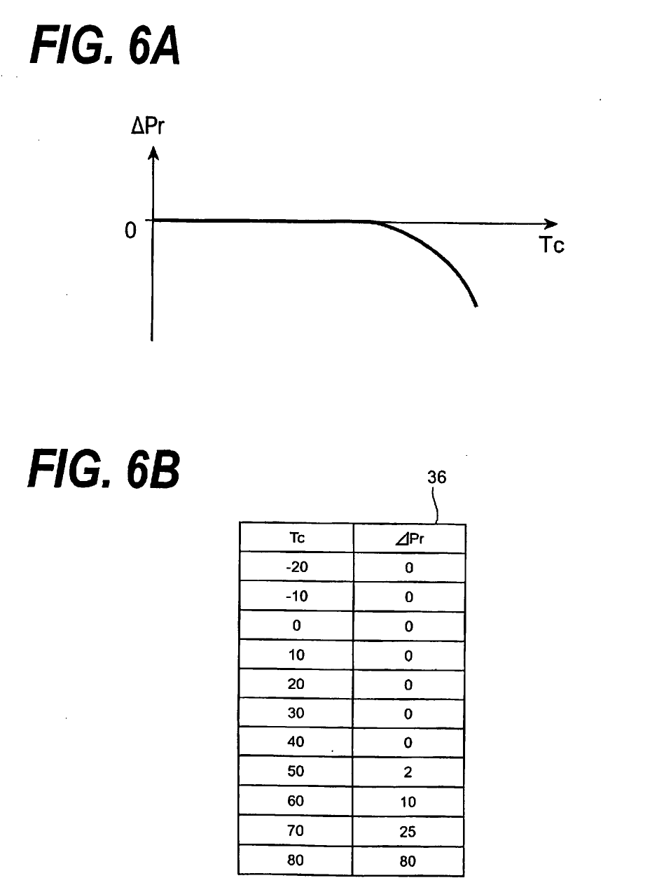

The target power Pr′ after corrected represents a value obtained by creating the LUT 34 on the basis of the Ib-Im characteristic 302 computed on the assumption that the optical output power of the LD is not saturated in FIG. 4 and correcting the extinction ratio so as to be stabilized at a target value when the APC is executed using the LUT 34 created. In this case, at a plurality of temperatures, the correction values ΔP (=Pr−Pr′) for the optical output power are previously measured, and the correction value ΔP at the temperature other than the measured temperatures is computed on the basis of the measured values by interpolation or extrapolation. The correction values thus computed are stored in the second storage 26 as the look-up table (LUT). FIG. 6A is a view showing the relationship between the temperatures Tc of the LD 12 and the correction values ΔPr. FIG. 6B shows the LUT 36 in which the temperatures Tc are correlated with the correction values ΔPr. Incidentally, for easiness of understanding, in FIG. 6B, the actual temperatures are described in the LUT 36, but instead of this, the values measured by the temperature monitor 28 may be stored.

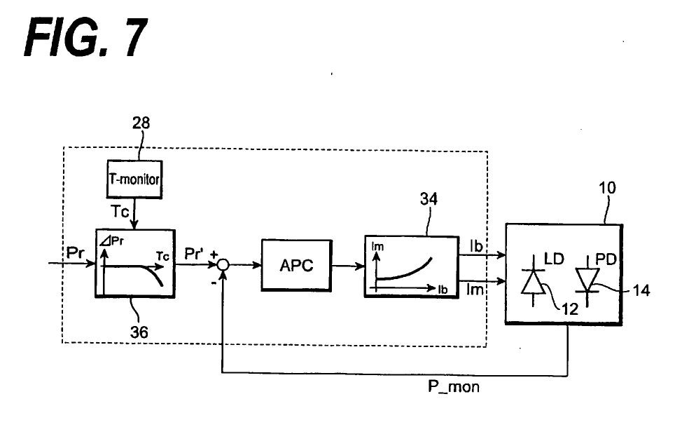

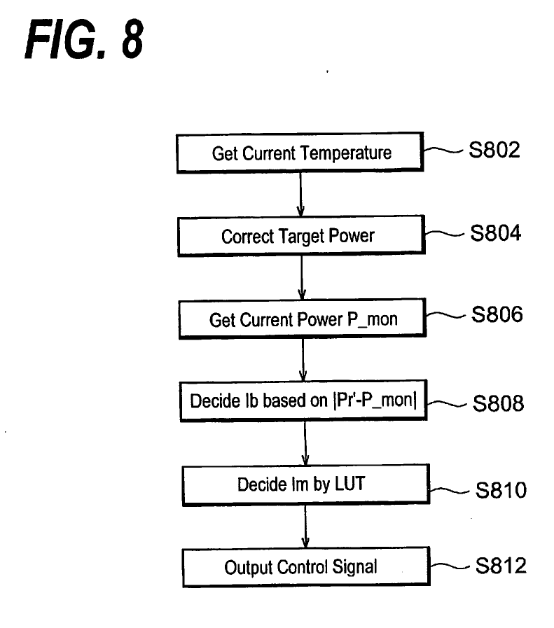

Now referring to FIGS. 7 and 8, an explanation will be given of the APC processing according to this embodiment. FIG. 7 is a block diagram schematically showing the APC according to this embodiment. FIG. 8 is a flowchart showing the procedure of the APC according to this embodiment.

The CPU 30 reads a current temperature from the temperature monitor 28 and converts it into an internally processed data (step S802). This temperature is the temperature Tc of the LD 12. Next, the CPU 30 corrects the target power Pr using the temperature Tc and the LUT 36 stored in the second storage 26 (step S804). In step S804, the CPU 30 decides the-correction value ΔPr referring to the LUT 36 and subtracts the correction value ΔPr from the target value Pr. Where the temperature Tc is different from the temperatures stored in the LUT 36, the value corresponding the temperature nearest to the current temperature of the stored temperatures may be set at the correction value ΔPr. Otherwise, the correction value ΔPr can be computed by interpolation or extrapolation of the data in the LUT 36.

Thereafter, the CPU 30 gets the current optical output power from the monitor PD 14 and converts it into an internally processed data P_Mon (step S806). Next, the CPU 30 computes a new bias current Ib on the basis of a difference between the target power Pr′ and the current optical output power P_Mon (step S808). In step S808, the CPU 30 computes the difference between the current optical output power P_Mon and the target power, and multiplies the difference (Pr′−P_Mon) thus obtained by a constant thereby to compute the new bias current Ib.

Next, the CPU 30 decides the modulation current Im on the basis of the LUT 34 stored in the second storage 26 (step S810). Thereafter, the CPU 30 creates a control signal corresponding to the bias current Ib and modulation current Im thus decided, and supplies it to the LD driver 18 (step S812). The LD driver 18 supplies the bias current Ib and modulation current Im according to the control signal, thereby driving the LD 12. The optical output power from the LD 12 is fed-back to the CPU 30 by the monitor PD 14, thus repeating the above APC processing. In this way, the APC loop taking the efficiency of the LD 12 at the high temperature into consideration can be realized.

As described above, when the efficiency of the LD 12 is greatly deteriorated at the high temperature, the APC circuit 20 reduces the target power Pr so that the extinction ratio of the LD 12 can be kept at the target value even at the high temperature. Although the target power is deteriorated at the high temperature, by setting the target power at a high value at the medium temperature or low temperature, the current supplied to the LD 12 can be increased, thereby extending the modulation frequency characteristic of the LD 12 to a higher frequency band.

Hitherto, this invention has been explained in detail on the basis of its embodiment. However, this invention should not be limited to the above embodiment. This invention can be realized in various manners within a scope not departing from its sprit. For example, in the above embodiment, the control data for deciding the correction value for the temperature of the LD 12 are stored in the second storage 26 as the LUT 36. However, instead of this, the coefficients bₙ, bₙ₋₁, . . . b₀ of the correction value ΔP represented by the n^{th}-order equation of ΔP=bₙTⁿ+bₙ₋₁Tⁿ⁻¹ . . . +b₀ may be stored. Further, in the above embodiment, after the target power Pr has been corrected, the actual power is get, i.e. measured. However, the optical output power may be measured before the target power Pr is corrected.

What is claimed is:

1. An automatic power control circuit for controlling an optical output power and an extinction ratio of a laser diode, comprising
a first storage for storing first control data correlating a bias current and a modulation current supplied to the laser diode so that the optical output power and the extinction ratio are set to predetermined values, respectively;
a central processing unit for measuring current optical output power of the laser diode, computing the bias current on the basis of a difference between the predetermined optical output power and the current optical output power, and deciding the modulation current corresponding to the bias current on the basis of the first control data;
a signal creating unit for creating a control signal corresponding to the bias current and the modulation current, and supplying the bias and modulation currents to the laser diode; and
a second storage for storing second control data correlating temperatures and correction values for the optical output power, wherein
the central processing unit corrects the optical output power on the basis of the second control data according to a current temperature of the laser diode, and computes the bias current using a difference between the corrected optical output power and the current optical output power.

2. The automatic power control circuit according to claim 1, wherein the correction value for the optical output power is an attenuation of the optical output power necessary to set the extinction ratio at the temperature of the laser diode to the predetermined value.

3. The automatic power control circuit according to claim 1, wherein the second control data are given as a look-up table for storing the temperatures of the laser diode and the plurality of the correction values, and
the central processing unit, when the current temperature is different from the temperatures stored in the look-up table, interpolates the correction values in the look-up table to compute the correction value corresponding to the current temperature.

4. A method for controlling a laser diode by supplying a bias current and a modulation current to the laser diode to stabilize an optical output power and an extinction ratio by comprising the steps of:
(a) measuring a current temperature of the laser diode;
(b) deciding a correction value corresponding to the current temperature;
(c) correcting a target optical output power of the laser diode on the basis of the correction value;
(d) measuring a current optical output power of the laser diode;
(e) deciding the bias current on the basis of a difference between the corrected target optical output power and the current optical output power;
(f) deciding the modulation current on the basis of the relationship between the target optical output power and the extinction ratio that simultaneously satisfies the target optical output power and the extinction ratio; and
(g) supplying the bias and modulation currents thus decided to the laser diode.

5. The method for controlling the laser diode according to claim 4, wherein the steps from (d) to (g) are repeated to control the optical output power and the extinction ratio.

6. The method for controlling the laser diode according to claim 4, further comprising a step of, prior to the step (a), creating first data correlating the bias current and the modulation current.

7. The method for controlling the laser diode according to claim 6, wherein the step (f) includes a step of interpolating the first data to decide the modulation current.

8. The method for controlling the laser diode according to claim 4, further comprising a step of, prior to the step (a), measuring the relationship between the temperature of the laser diode and the optical output power satisfying the extinction ratio, thereby creating second data correlating each temperature and a correction value of the optical output power.

9. The method for controlling the laser diode according to claim 8, wherein the step (b) includes a step of interpolating the second data to decide the correction value.

10. The method for controlling the laser diode according to claim 4, wherein the step (d) is executed prior to the steps from (a) to (c).
